(19) United States
(12) Patent Application Publication
(10) Pub. No.: US 2014/0188359 A1
(43) Pub. Date: Jul. 3, 2014

(54) ELECTRIC BRAKE ASSIST SYSTEM FOR VEHICLE USE

(71) Applicant: AUTOMOTIVE RESEARCH & TESTING CENTER, Lugong (TW)

(72) Inventors: Jiun-Jie Chen, Taiwan (CN); Bo-Ruei Chen, Taiwan (CN); Shih-Chieh Huang, Taiwan (CN)

(73) Assignee: Automotive Research & Testing Center, Lugong (TW)

(21) Appl. No.: 13/727,746

(22) Filed: Dec. 27, 2012

(51) Int. Cl. B60T 13/52

(52) U.S. Cl. CPC B60T 13/52
USPC 701/70

(57) ABSTRACT

An electric brake assist system is adapted for use with a vehicle, and includes a vacuum pump unit including an electric vacuum pump connected to the vacuum tube unit, an electric pressure sensing unit for detecting a vacuum degree in a vacuum tube unit of the vehicle, and an electric control unit to sense an electrical parameter associated with operation of the vehicle and the brake assist system. The electric control unit includes a controller configured to operate in at least one of a plurality of failure protection modes and system operation modes according to the detected vacuum degree and the sensed electrical parameter.

### BACKGROUND OF THE INVENTION

1. Field of the Invention

The invention relates to a brake assist system, and more particularly to an electric brake assist system.

2. Description of the Related Art

FIG. 1 shows a conventional brake assist system adapted for use with an electric vehicle including a brake booster 11. The brake assist system includes a vacuum tube unit 12 coupled to the brake booster 11, an electric vacuum pump 13 coupled to the vacuum tube unit 12, a mechanical pressure sensor 14 disposed on the vacuum tube unit 12, a mechanical relay 15 coupled to the electric vacuum pump 13 and the mechanical pressure sensor 14, and a battery 16 for providing electricity.

When a user steps on the brake of the electric vehicle and a pressure in the vacuum tube unit 12 sensed by the mechanical pressure sensor 14 is not lower than a preset target value, the mechanical relay 15 is controlled to make electrical connection between the electric vacuum pump 13 and the battery 16 for activation of the electric vacuum pump 13. The electric vacuum pump 13 removes gas from the vacuum tube unit 12, such that the pressure in the vacuum tube unit 12 is lower than the preset target value, ensuring normal operation of the brake booster 11.

The mechanical pressure sensor 14 does not have sufficient accuracy to provide precise information in general, and provides only information that the pressure is higher or lower than the preset target value for switching the mechanical relay 15, so that it is unreliable to achieve precise control of the system.

When the electric vacuum pump 13 breaks down, or is unable to operate normally due to failure of peripheral circuits, the pressure in the vacuum tube unit 12 is unable to be decreased to be lower than the preset target value, resulting in abnormal operations of the brake booster 11. At this time, the vehicle speed may be unable to be reduced, and a driver of the vehicle will not be aware of the failure of the brake until the brake pedal is stepped on, resulting in danger to the driver and the passenger, and safety concerns on the road.

### SUMMARY OF THE INVENTION

Therefore, an object of the present invention is to provide an electric brake assist system that may achieve relatively precise pressure control, failure detection, and failure protection.

According to the present invention, an electric brake assist system is adapted for use with a vehicle. The vehicle includes a brake booster and a vacuum tube unit coupled to the brake booster. The electric brake assist system comprises:

a vacuum pump unit including an electric vacuum pump to be connected to the vacuum tube unit;

an electric pressure sensing unit to be disposed on the vacuum tube unit for detecting a vacuum degree in the vacuum tube unit; and

an electric control unit coupled to the electric vacuum pump and the electric pressure sensing unit, operable to sense an electrical parameter associated with operation of at least one of the vehicle and the electric brake assist system, and including a controller configured to operate in at least one of a plurality of failure protection modes and system operation modes according to the vacuum degree detected by the electric pressure sensing unit and the electrical parameter sensed by the electric control unit.

The system operation modes include an initial operation mode, and the controller is operable under the initial operation mode to output an operation signal for driving the electric vacuum pump when the vacuum degree detected by the electric pressure sensing unit is lower than a preset value.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic diagram showing a conventional brake assist system;

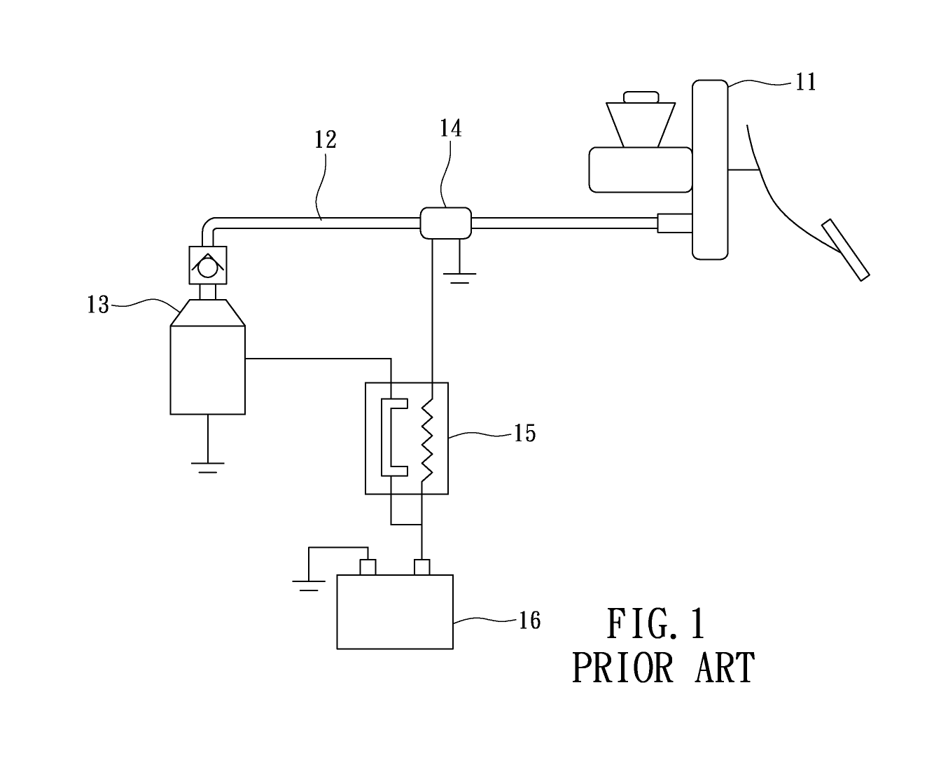

FIG. 2 is a schematic diagram showing a preferred embodiment of the electric brake assist system according to the present invention;

FIG. 3 is a block diagram of the preferred embodiment;

FIG. 4 is a flow chart illustrating operation of a controller of the preferred embodiment under an initial operation mode;

FIG. 5 is a flow chart illustrating operation of the controller of the preferred embodiment under a vacuum tube failure protection mode;

FIG. 6 is a flow chart illustrating another implementation of operation of the controller of the preferred embodiment under the vacuum tube failure protection mode;

FIG. 7 is a flow chart illustrating operation of the controller of the preferred embodiment under a battery voltage failure protection mode;

FIG. 8 is a flow chart illustrating operation of the controller of the preferred embodiment under a vacuum pump failure protection mode;

FIG. 9 is a schematic diagram showing a switch unit of the preferred embodiment;

FIG. 10 is a flow chart illustrating operation of the controller of the preferred embodiment under a power failure protection mode; and

FIG. 11 is a flow chart illustrating operation of the controller of the preferred embodiment under the power failure protection mode.

### DETAILED DESCRIPTION OF THE PREFERRED EMBODIMENT

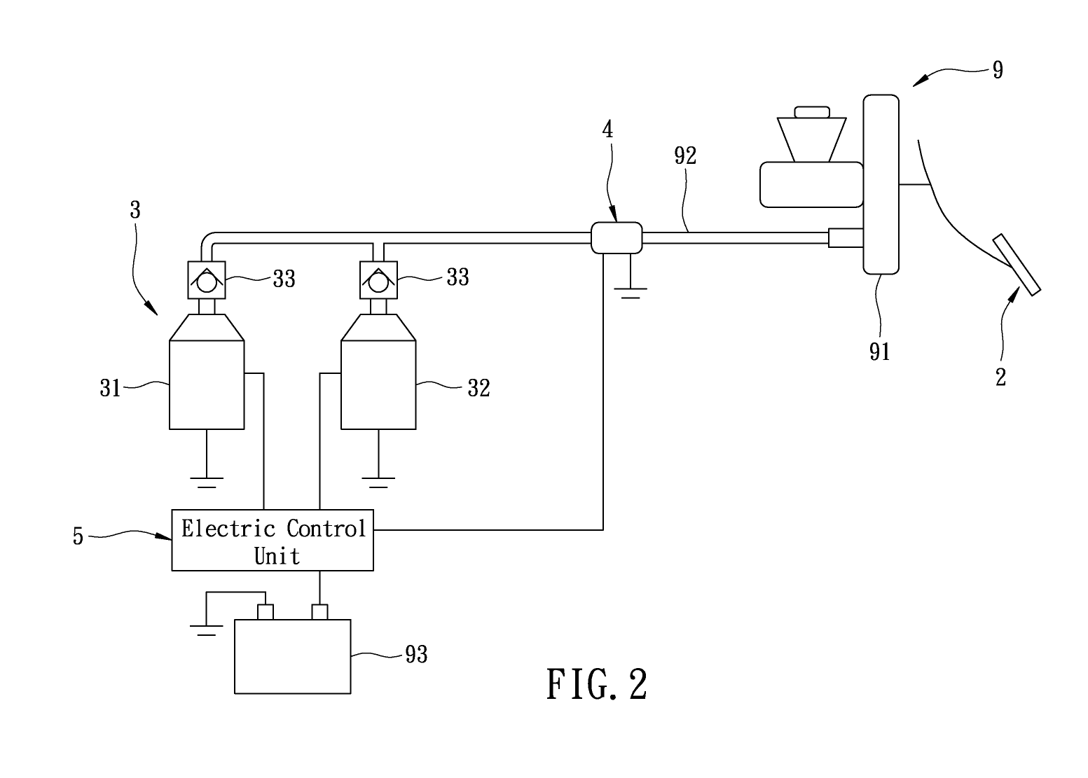

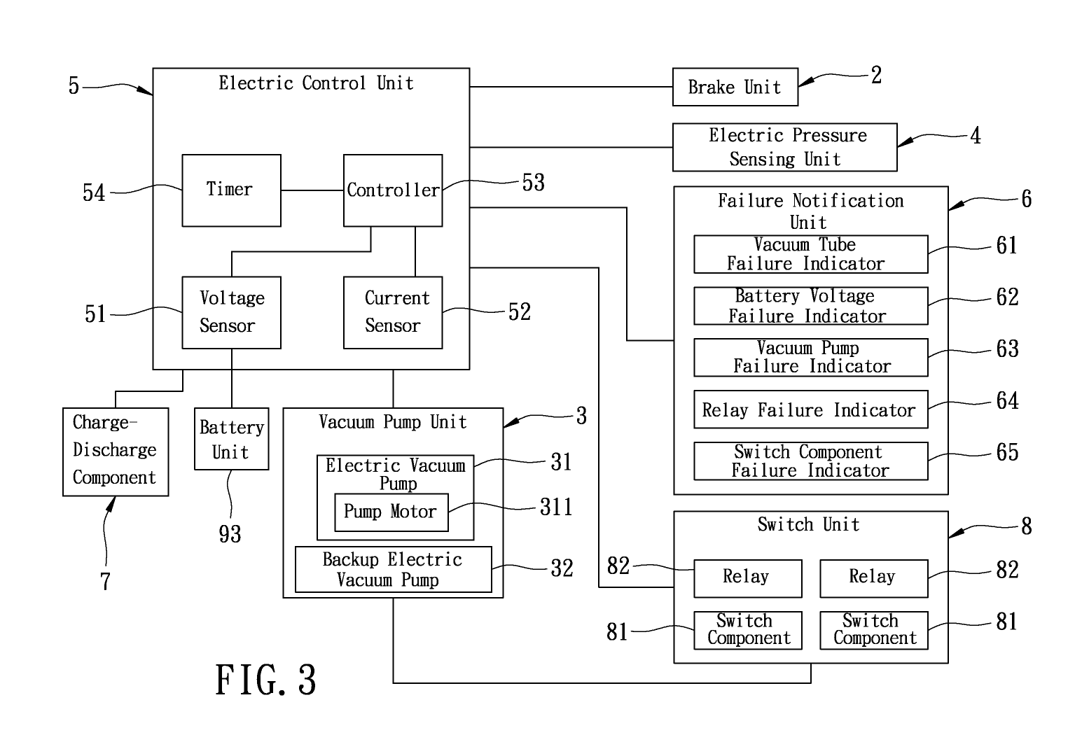

Referring to FIG. 2 and FIG. 3, the preferred embodiment of the electric brake assist system according to this invention is shown to be adapted for use with a vehicle 9. In this embodiment, the vehicle 9 is an electric vehicle and includes a brake unit 2 that provides a brake signal in response to a brake operation of a user, a brake booster 91 coupled to the brake unit 2, a vacuum tube unit 92 coupled to the brake booster 91, and a battery 93 for providing electricity. The electric brake assist system includes a vacuum pump unit 3, an electric pressure sensing unit 4, an electric control unit 5, a failure notification unit 6, and a charge-discharge component 7 (such as a supercapacitor) coupled to the electric control unit 5 and serving as a backup electric power source.

The vacuum pump unit 3 includes an electric vacuum pump 31 connected to the vacuum tube unit 92, a backup electric vacuum pump 32 connected to the vacuum tube unit 92, and two check valves 33. The electric vacuum pump 31 includes a pump motor 311. One of the check valves 33 is disposed between the vacuum tube unit 92 and the electric vacuum pump 31 for preventing gas flow from the electric vacuum pump 31 to the vacuum tube unit 92, and the other check valve 33 is disposed between the vacuum tube unit 92 and the backup electric vacuum pump 32 for preventing gas flow from the backup electric vacuum pump 32 to the vacuum tube unit 92.

The electric pressure sensing unit 4 is disposed on the vacuum tube unit 92 for detecting a vacuum degree in the vacuum tube unit 92.

The electric control unit 5 is coupled to the brake unit 2, the electric vacuum pump 31, the backup electric vacuum pump 32, the electric pressure sensing unit 4, and the failure notification unit 6, and is operable to sense an electrical parameter associated with operation of at least one of the vehicle and the electric brake assist system. In this embodiment, the electric control unit 5 includes a voltage sensor 51 coupled to the battery unit 93 for sensing a voltage of the battery unit 93, a current sensor 52 coupled to the pump motor 311 for sensing a current of the pump motor 311, a controller 53 coupled the voltage sensor 51 and the current sensor 52, and a timer 54 coupled to the controller 53. The electrical parameter includes the voltage sensed by the voltage sensor 51 and the current sensed by the current sensor 52. The controller 53 is configured to operate in at least one of a plurality of failure protection modes and system operation modes according to the vacuum degree detected by the electric pressure sensing unit 4 and the electrical parameter sensed by the electric control unit 5.

The failure notification unit 6 is adapted to provide a notification that indicates failures corresponding to the failure protection modes. In this embodiment, the failure notification unit 6 includes a vacuum tube failure indicator 61, a battery voltage failure indicator 62, and a vacuum pump failure indicator 63.

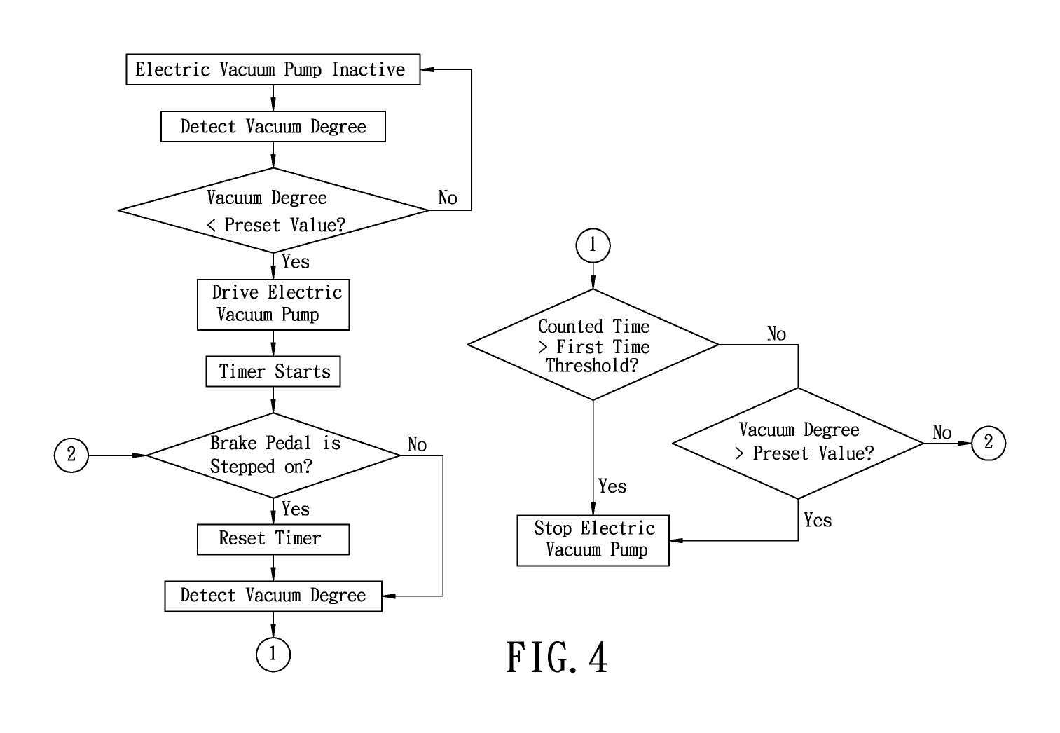

In this embodiment, the system operation modes include an initial operation mode, a first operation mode, and a second operation mode. Referring to FIGS. 2, 3, and 4, the controller 53 that operates under the initial operation mode outputs an operation signal for driving the electric vacuum pump 31 to remove gas from the vacuum tube unit 92 when the vacuum degree detected by the electric pressure sensing unit 4 is lower than a preset value, and controls the timer 54 to start counting time from beginning of operation of the electric vacuum pump 31. After the timer 54 starts counting time, the controller 53 resets the timer 54 upon receipt of the brake signal by the controller 53. Otherwise, the timer 54 keeps counting time. The controller 53 stops operation of the electric vacuum pump 31 when the time counted by the timer 54 is greater than a first time threshold.

In this embodiment, the failure protection modes include a vacuum tube failure protection mode, a battery voltage failure protection mode, and a vacuum pump failure protection mode.

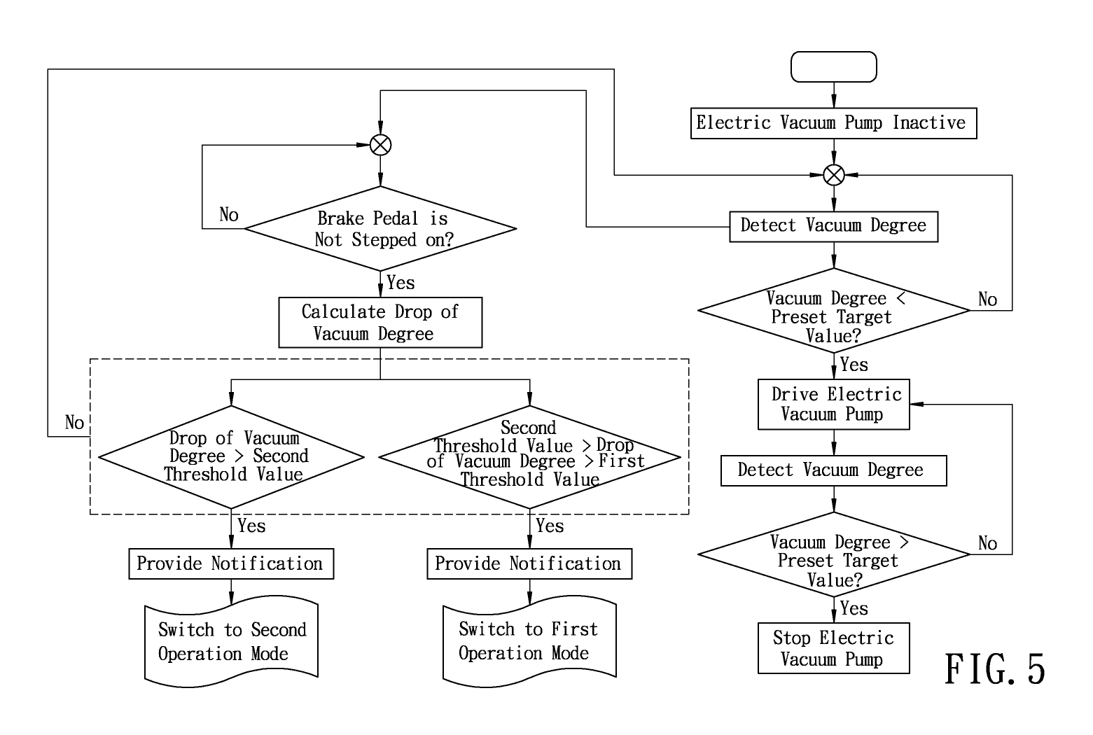

Referring to FIGS. 2, 3, and 5, the controller 53 that operates under the vacuum tube failure protection mode calculates a drop of the vacuum degree in the vacuum tube unit 92 within a time period during non-receipt of the brake signal by the electric control unit 5. Under the vacuum tube failure protection mode, when the drop of the vacuum degree in the vacuum tube unit 92 within the time period is greater than a first threshold value and smaller than a second threshold value that is larger than the first threshold value, which indicates that the vacuum tube unit 92 is damaged, the controller 53 controls the failure notification unit 6 to turn on the vacuum tube failure indicator 61, and is switched to operate in the first operation mode. The controller 53 that operates under the first operation mode outputs the operation signal to drive both of the electric vacuum pump 31 and the backup electric vacuum pump 32 at the same time for accelerating removal of the gas in the vacuum tube unit 92 when the vacuum degree detected by the electric pressure sensing unit 4 is lower than a preset target value. If there is no backup electric vacuum pump 32 installed in the electric brake assist system, the controller 53 drives only the electric vacuum pump 31.

Under the vacuum tube failure protection mode, when the drop of the vacuum degree in the vacuum tube unit 92 within the time period is greater than the second threshold value, which indicates that the vacuum tube unit 92 is seriously damaged, the controller 53 controls the failure notification unit 6 to turn on the vacuum tube failure indicator 61, and is switched to operate in the second operation mode. The controller that operates under the second operation mode outputs the operation signal to drive both of the electric vacuum pump 31 and the backup electric vacuum pump 32 at the same time only when the electric control unit 5 receives the brake signal from the brake unit 2. If there is no backup electric vacuum pump 32 installed in the electric brake assist system, the controller 53 drives only the electric vacuum pump 31. Since the vacuum tube unit 92 is seriously damaged, the vacuum degree therein will keep being lower than the preset target value, and the operation signal is outputted only when the electric control unit 5 receives the brake signal for preventing the issue of overheating from high-frequency operation of the electric vacuum pump 31.

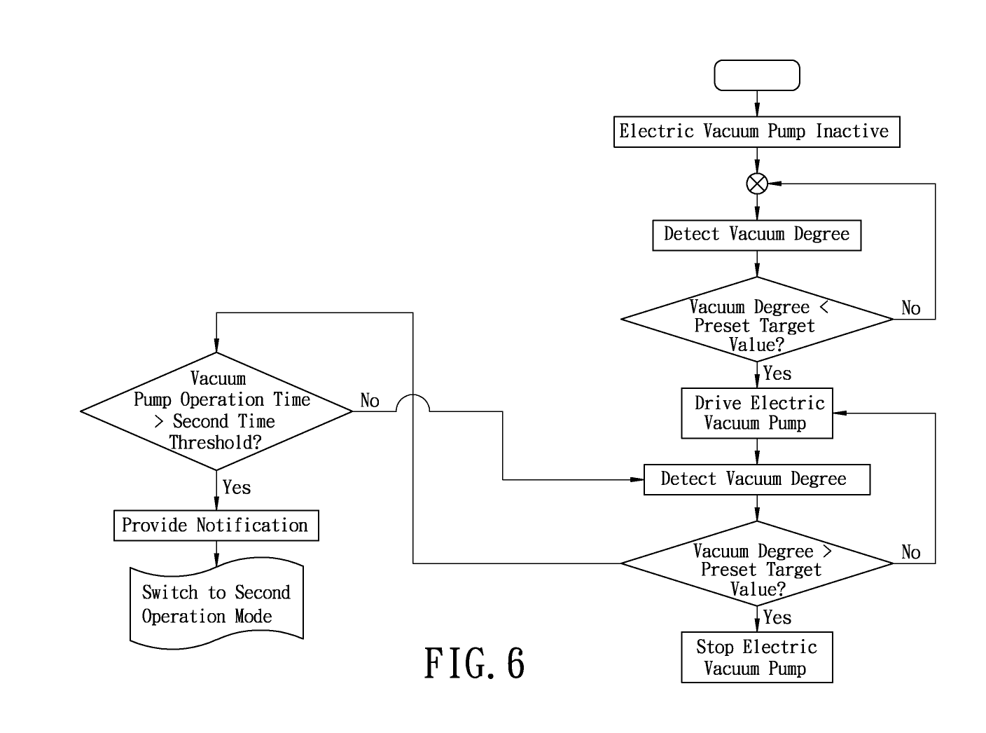

Referring to FIG. 3 and FIG. 6 for another implementation of the vacuum tube failure protection mode, the controller 53 that operates under this vacuum tube failure protection mode controls the timer 54 to start counting time from beginning of operation of the electric vacuum pump 31. The controller 53 is switched to operate in the second operation mode and controls the failure notification unit 6 to turn on the vacuum tube failure indicator 61 to provide a notification that indicates failure of the vacuum tube unit 92 when the time counted by the timer 54 has exceeded a second time threshold.

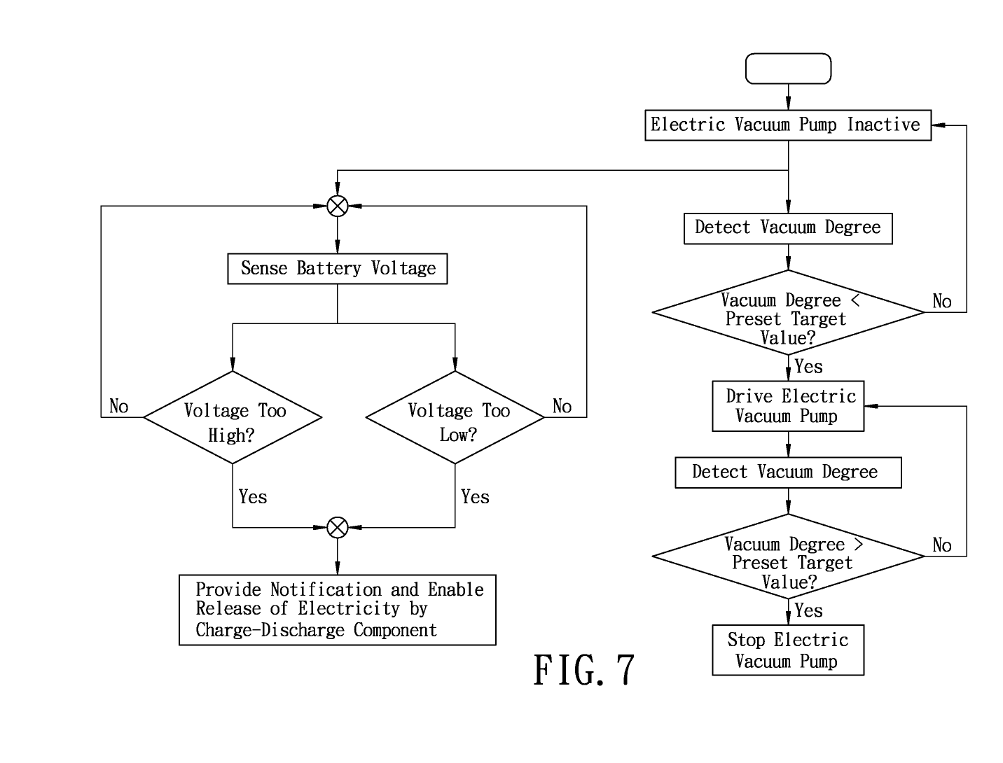

Referring to FIG. 3 and FIG. 7, the controller 53 that operates under the battery voltage failure protection mode controls the failure notification unit 6 to turn on the battery voltage failure indicator 62 and to enable the charge-discharge component 7 to release electricity stored therein when the voltage sensed by the voltage sensor 51 does not fall within a predetermined voltage range.

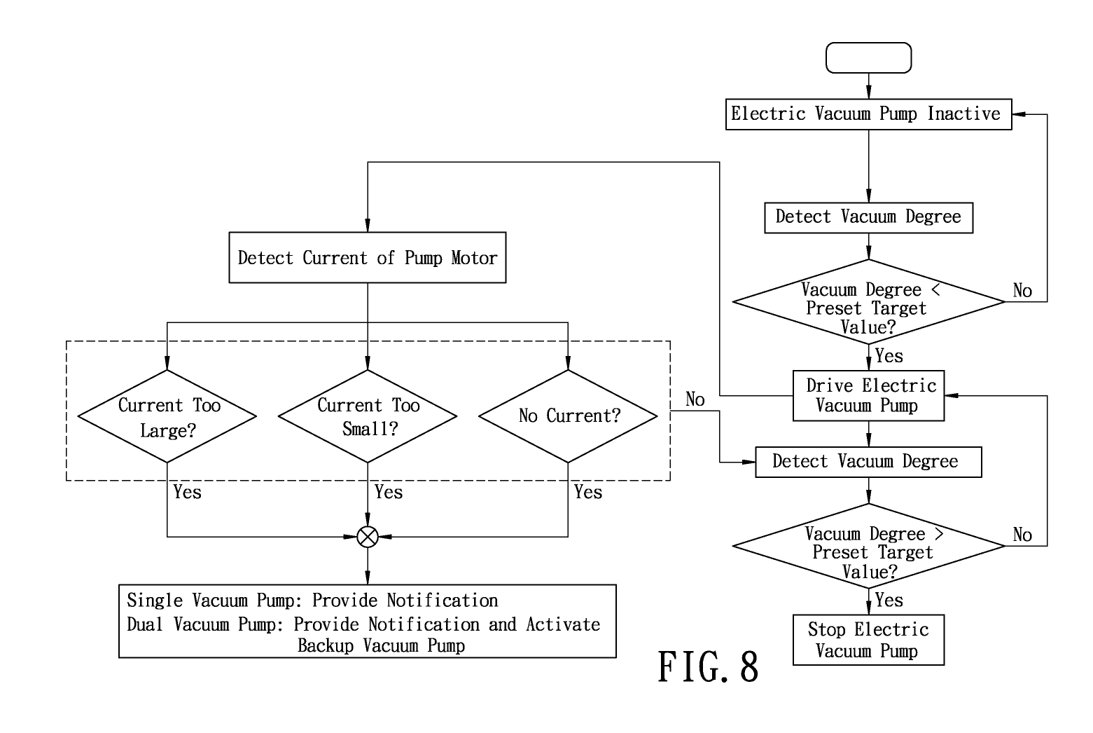

Referring to FIG. 3 and FIG. 8, the controller that operates under the vacuum pump failure protection mode controls the failure notification unit 6 to turn on the vacuum pump failure indicator 63 and to activate the backup electric vacuum pump 32 when the current sensed by the current sensor 52 does not fall within a predetermined current range. If there is no backup electric vacuum pump 32 installed in the electric brake assist system, the controller 53 controls only the failure notification unit 6 to turn on the vacuum pump failure indicator 63.

When the current sensed by the current sensor 52 is too large, this indicates that an internal coil of the pump motor 311 may have burnt out. When the current sensed by the current sensor 52 is too small, this indicates that an internal carbon brush of the pump motor 311 may have dropped. When there is no current sensed by the current sensor 52, this indicates that a control wire of the pump motor 311 may have dropped or broken.

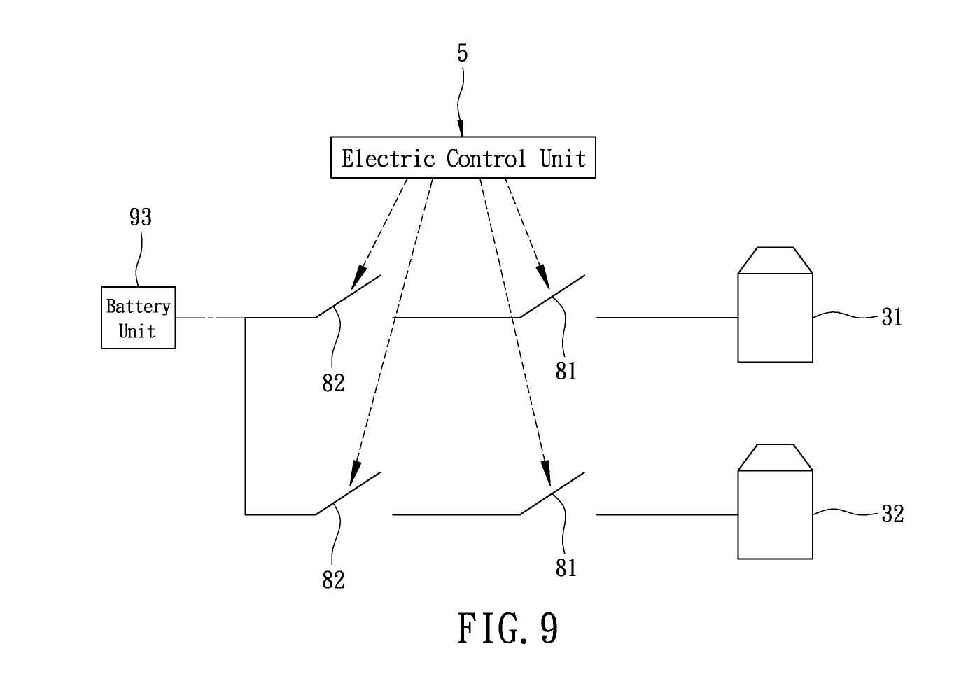

Referring to FIG. 3 and FIG. 9, the electric brake assist system according to this invention may further include two switch units 8, the failure protection modes may further include a power failure protection mode, and the failure notification unit 6 may further include a relay failure indicator 64 and a switch component failure indicator 65. Each of the switch units 8 includes a switch component 81 and a relay 82 that are coupled in series and that are coupled to and controlled by the electric control unit 5. One of the switch units 8 is adapted for coupling the electric vacuum pump 31 to the battery unit 93 (an electric power source), and the other one of the switch units 8 is adapted for coupling the backup electric vacuum pump 32 to the battery unit 93. In this embodiment, the switch components 81 of the switch units 8 are respectively coupled to the electric vacuum pump 31 and the backup electric vacuum pump 32, and both of the relays 82 of the switch units 8 are coupled to the battery unit 93. In other embodiments, the switch component 81 and the relay 82 may be exchanged for each of the switch units 8. If there is no backup electric vacuum pump 32 installed in the electric brake assist system, the electric brake assist system may only include a switch unit 8 controlled by the electric control unit 5 for coupling the electric vacuum pump 31 to the battery unit 93. Since the switch component 81 and the relay 82 are coupled in series for each switch unit 8, the electric vacuum pump 31 (or the backup electric vacuum pump 32) is drivable only when the switch component 81 and the relay 82 are activated to conduct at the same time.

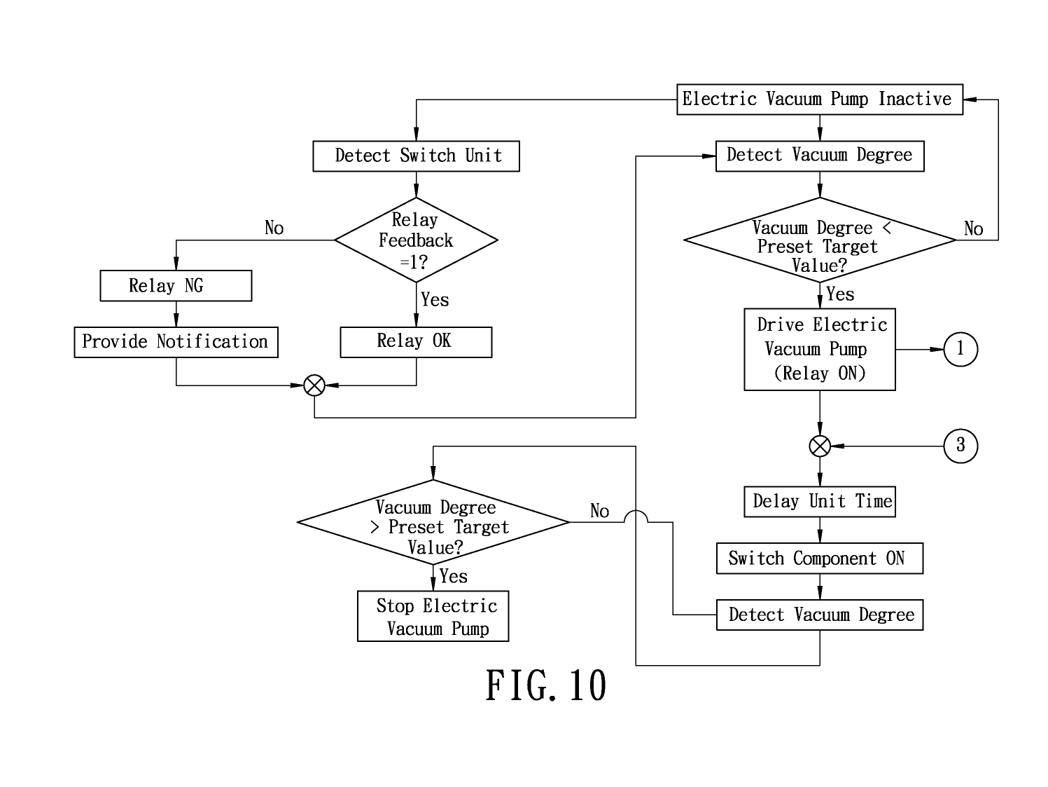

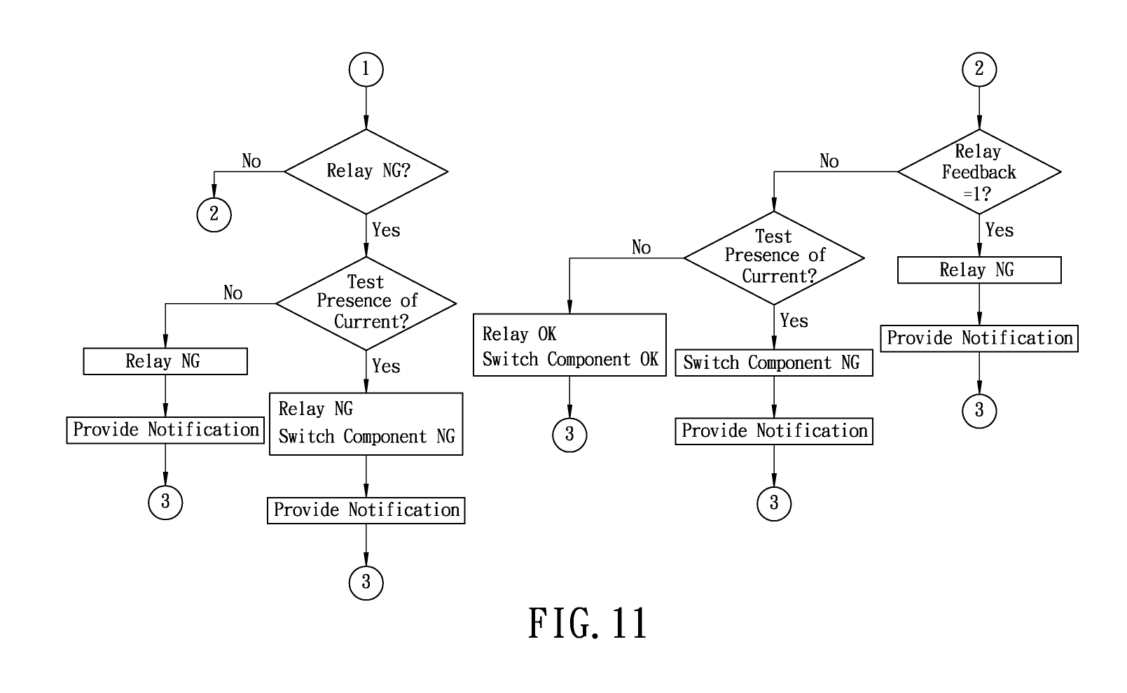

Referring to FIGS. 3, 10, and 11, the controller 53 that operates under the power failure protection mode controls the switch component 81 and the relay 82 of the switch unit 8 that is adapted for coupling the electric vacuum pump 31 and the battery unit 93 to make and break electrical connection respectively in a predetermined sequence, so as to sense a feedback response from the relay 82 and a current flow from the switch component 81. In detail, the controller 53 first confirms whether the relay 82 is activated. Initially, the relay 82 and the switch component 81 should be inactive, such that when the feedback response indicates inactivation (e.g., feedback response=1) of the relay 82, the relay 82 is determined to operate normally, or abnormally when otherwise. The relay 82 is then activated and confirmed anew. When the feedback response indicates activation of the relay 82 (e.g., feedback response≠1), the relay 82 is determined to operate normally, or abnormally when otherwise. Then, the controller 53 tests presence of current flow. Inactivation of the switch component 81 is indicated when no current flow is tested, which is determined to be normal, and abnormality is determined when otherwise. When at least one of the feedback response and the current flow sensed by the controller 53 corresponds to an abnormal operating condition, the controller 53 controls the failure notification unit 6 to turn on the corresponding one of the relay failure indicator 64 and the switch component failure indicator 65 and activates the backup electric vacuum pump 32 in a manner based upon the feedback response and the current flow sensed by the controller 53, which will be illustrated hereinafter. If there is no backup electric vacuum pump 32 installed in the electric brake assist system, the controller 53 only controls the failure notification unit 6 to turn on the corresponding one of the relay failure indicator 64 and the switch component failure indicator 65.

The relay 82 is usually damaged in a form of an open circuit as a result of carbon deposition at a contact thereof, or in a form of a short circuit as a result of sintering at contacts thereof. The switch component is usually formed of metal-oxide-semiconductor field-effect transistors (MOSFETs), and is usually damaged in a form of a short circuit or an open circuit as a result of being burnt out.

When the relay 82 is damaged due to a short circuit, activation of the electric vacuum pump 31 can still be controlled through the switch component 81 to ensure normal operation of the electric brake assist system. When the relay 82 is damaged due to an open circuit, the controller 53 is unable to control the electric vacuum pump 31, and the backup electric vacuum pump 32 must be activated.

When the MOSFETs of the switch component 81 are damaged due to a short circuit, activation of the electric vacuum pump 31 can still be controlled through the relay 82 to ensure normal operation of the electric brake assist system. When the switch component 81 is damaged due to an open circuit, the controller 53 is unable to control the electric vacuum pump 31, and the backup electric vacuum pump 32 must be activated.

It should be noted that, in other embodiments, the vacuum failure indicator 61, the battery voltage failure indicator 62, the vacuum pump failure indicator 63, the relay failure indicator 64, and the switch component failure indicator 65 may be replaced using a single failure indicator. When any of the aforementioned failures happens, the controller 53 controls the failure notification unit 6 to turn on the failure indicator.

The electric brake assist system of this invention has the following advantages:

1. By using the electric pressure sensing unit 4 instead of the mechanical pressure sensor used in the prior art, the vacuum degree in the vacuum tube unit 92 may be measured precisely, and the required vacuum degree of the brake booster 91 may thus be controlled through calculation and determination by the electric control unit 5.

2. Through switching of operation of the controller 53 among the vacuum tube failure protection mode, the battery voltage failure protection mode, the vacuum pump failure protection mode, and the power failure protection mode, states of the system may be actively detected, and a notification may be provided to the user when any one of the failure modes happens, so as to ensure safety during driving.

3. Through switching of operation of the controller 53 between the first and second operation modes, the activation time of the electric vacuum pump 31 and the backup electric vacuum pump 32 may be adjusted according to different conditions, so as to prevent overheating from high-frequency operation, and thus enhance safety during driving.

To sum up, the electric brake assist system of this invention may actively detect different types of failures, provide corresponding failure notifications, achieve relatively precise pressure control compared to the prior art, and provide failure protection.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An electric brake assist system adapted for use with a vehicle, the vehicle including a brake booster and a vacuum tube unit coupled to the brake booster, said electric brake assist system comprising:
a vacuum pump unit including an electric vacuum pump to be connected to the vacuum tube unit;
an electric pressure sensing unit to be disposed on the vacuum tube unit for detecting a vacuum degree in the vacuum tube unit; and
an electric control unit coupled to said electric vacuum pump and said electric pressure sensing unit, operable to sense an electrical parameter associated with operation of at least one of the vehicle and said electric brake assist system, and including a controller configured to operate in at least one of a plurality of failure protection modes and system operation modes according to the vacuum degree detected by said electric pressure sensing unit and the electrical parameter sensed by said electric control unit,
wherein the system operation modes include an initial operation mode, and said controller is operable under the initial operation mode to output an operation signal for driving said electric vacuum pump when the vacuum degree detected by said electric pressure sensing unit is lower than a preset value.

2. The electric brake assist system as claimed in claim 1, wherein the system operation modes further include a first operation mode, and said controller is operable under the first operation mode to output the operation signal when the vacuum degree detected by said electric pressure sensing unit is lower than a preset target value.

3. The electric brake assist system as claimed in claim 2, the vehicle further including a brake unit that provides a brake signal in response to a brake operation of a user, wherein said electric control unit is to be coupled to the brake unit for receiving the brake signal therefrom, said system operation modes further including a second operation mode, said controller being operable under the second operation mode to output the operation signal only when said electric control unit receives the brake signal from the brake unit.

4. The electric brake assist system as claimed in claim 3, wherein said vacuum pump unit further includes a backup electric vacuum pump to be connected to the vacuum tube unit and coupled to said electric control unit so as to receive and be driven by the operation signal.

5. The electric brake assist system as claimed in claim 3, wherein the failure protection modes include a vacuum tube failure protection mode, and said controller is operable under the vacuum tube failure protection mode to calculate a drop of the vacuum degree in the vacuum tube unit within a time period during non-receipt of the brake signal by said electric control unit;
wherein, under the vacuum tube failure protection mode, when the drop of the vacuum degree in the vacuum tube unit within the time period is greater than a first threshold value and smaller than a second threshold value that is larger than the first threshold value, said controller is switched to operate in the first operation mode; and
wherein, under the vacuum tube failure protection mode, when the drop of the vacuum degree in the vacuum tube unit within the time period is greater than the second threshold value, said controller is switched to operate in the second operation mode.

6. The electric brake assist system as claimed in claim 5, further comprising a failure notification unit that is coupled to said electric control unit;
wherein, under the vacuum tube failure protection mode, when the drop of the vacuum degree in the vacuum tube unit within the time period is greater than the first threshold value, said controller controls said failure notification unit to provide a notification that indicates failure of the vacuum tube unit.

7. The electric brake assist system as claimed in claim 3, wherein said electric control unit further includes a timer coupled to said controller, and the failure protection modes include a vacuum tube failure protection mode, said controller being operable under the vacuum tube failure protection mode to control said timer to start counting time from beginning of operation of said electric vacuum pump;
wherein, under the vacuum tube failure protection mode, said controller is switched to operate in the second operation mode when the time counted by said timer has exceeded a time threshold.

8. The electric brake assist system as claimed in claim 7, further comprising a failure notification unit coupled to said electric control unit,
wherein, under the vacuum tube failure protection mode, said controller is further operable to control said failure notification unit to provide a notification that indicates failure of the vacuum tube unit when the time counted by said timer has exceeded the time threshold.

9. The electric brake assist system as claimed in claim 1, the vehicle further including a battery unit for providing electricity, said electric brake assist system further comprising a failure notification unit coupled to said electric control unit, said electric control unit further including a voltage sensor to be coupled to the battery unit for sensing a voltage of the battery unit, the failure protection modes including a battery voltage failure protection mode, said controller being operable under the battery voltage failure protection mode to control said failure notification unit to provide a notification that indicates failure of the battery unit when the voltage sensed by said voltage sensor does not fall within a predetermined voltage range.

10. The electric brake assist system as claimed in claim 9, further comprising a charge-discharge component coupled to said electric control unit and serving as a backup electric power source, said controller being further operable to enable said charge-discharge component to release electricity stored therein when the voltage sensed by said voltage sensor does not fall within the predetermined voltage range.

11. The electric brake assist system as claimed in claim 1, further comprising a failure notification unit coupled to said electric control unit, said electrical vacuum pump including a pump motor, said electric control unit further including a current sensor coupled to said pump motor for sensing a current of said pump motor, the failure protection modes including a vacuum pump failure protection mode, said controller being operable under the vacuum pump failure protection mode to control said failure notification unit to provide a notification that indicates failure of said electric vacuum pump when the current sensed by said current sensor does not fall within a predetermined current range.

12. The electric brake assist system as claimed in claim 1, wherein said electric vacuum pump includes a pump motor, said electric control unit further includes a current sensor coupled to said pump motor for sensing a current of said pump motor, said vacuum pump unit further includes a backup electric vacuum pump to be connected to the vacuum tube unit and coupled to said electric control unit so as to receive and be driven by the operation signal, and the failure protection modes include a vacuum pump failure protection mode, said controller being operable under the vacuum pump failure protection mode to activate said backup electric vacuum pump when the current sensed by said current sensor does not fall within a predetermined current range.

13. The electric brake assist system as claimed in claim 1, further comprising a switch unit that is coupled to said electric vacuum pump, and a failure notification unit that is coupled to said electric control unit,
wherein said switch unit includes a switch component and a relay that are coupled in series and that are coupled to and controlled by said electric control unit, one of said switch component and said relay being coupled to said electric vacuum pump, the other one of said switch component and said relay to be coupled to an electric power source, the failure protection modes including a power failure protection mode, said controller being operable under the power failure protection mode to control said switch component and said relay to make and break electrical connection respectively in a predetermined sequence, so as to sense a feedback response from said relay and a current flow from said switch component, and to control said failure notification unit to provide a notification that indicates failure of said switch unit when at least one of the feedback response and the current flow sensed by said controller corresponds to an abnormal operating condition.

14. The electric brake assist system as claimed in claim 1, further comprising two switch units, wherein said vacuum pump unit further includes a backup electric vacuum pump to be connected to the vacuum tube unit and coupled to said electric control unit so as to receive and be driven by the operation signal,
each of said switch units including a switch component and a relay that are coupled in series and that are coupled to and controlled by said electric control unit, one of said switch units being adapted for coupling said electric vacuum pump to an electric power source, the other one of said switch unit being adapted for coupling said backup electric vacuum pump to the electric power source.

15. The electric brake assist system as claimed in claim 1, wherein said vacuum pump unit further includes a check valve to be disposed between the vacuum tube unit and said electric vacuum pump for preventing gas flow from said electric vacuum pump to the vacuum tube unit.

16. The electric brake assist system as claimed in claim 15, wherein said vacuum pump unit further includes a backup electric vacuum pump to be connected to the vacuum tube unit and coupled to said electric control unit so as to receive and be driven by the operation signal, and another check valve to be disposed between the vacuum tube unit and said backup electric vacuum pump for preventing gas flow from said backup electric vacuum pump to the vacuum tube unit.
